(19) United States
(12) Patent Application Publication
(10) Pub. No.: US 2014/0013599 A1
(43) Pub. Date: Jan. 16, 2014

(54) Method of Manufacturing Fan Blade Shields

(71) Applicant: Changsheng Guo, South Windsor, CT (US)

(72) Inventor: Changsheng Guo, South Windsor, CT (US)

(73) Assignee: Pratt & Whitney

(21) Appl. No.: 13/546,762

(22) Filed: Jul. 11, 2012

(51) Int. Cl. B23K 3/00

(52) U.S. Cl. 29/888.012

(57) ABSTRACT

A method for manufacturing a fan blade shield having a sheath cavity made from a hard metal material is disclosed The method may comprise: performing a sheath cavity grinding step for the fan blade shield; and performing a sheath cavity bottom grinding step for the fan blade shield. A method for forming a fan blade is disclosed. The method may comprise: obtaining a fan blade body; obtaining a fan blade shield made from a hard metal material and having a sheath cavity match a leading edge of the fan blade body, the fan blade shield being obtained by a process comprising: performing a sheath cavity grinding step for the fan blade shield; and performing a sheath cavity bottom grinding step for the fan blade shield; and attaching the fan blade shield to the leading edge of the fan blade body to produce the fan blade.

### FIELD OF THE DISCLOSURE

The present disclosure generally relates to gas turbine engines and, more particularly, relates to a fan blade of a gas turbine engine.

### BACKGROUND OF THE DISCLOSURE

A gas turbine engine typically includes a fan section, a compressor, at least one combustor, and a turbine. The fan section, which is at an axially forward end of the engine, comprises a rotatable hub, an array of fan blades projecting radially from the hub and a fan casing encircling the blade array. In operation, the fan section forces air into a flow passage through an axial compressor, in which the air is pressurized and is then directed toward the combustor. Fuel is continuously injected into the combustor together with the compressed air. The mixture of fuel and air is ignited to create combustion gases that enter the turbine, which is rotatably driven as the high temperature, high pressure combustion gases expand in passing over the blades forming the turbine. Since the turbine is connected to the compressor via a shaft, the combustion gases that drive the turbine also drive the compressor, thereby restarting the ignition and combustion cycle.

Currently fan blades are typically made of low-density metals, for example, aluminum, or composite materials, for example, graphite fiber reinforcements within an epoxy matrix, to decrease the weight. During operation of the engine, and in particular, during movement of an aircraft powered by the engine, the fan blades may be damaged by foreign objects entrained in the inlet of the gas turbine engine. The foreign objects may include, for example, birds, sand, rocks, rain, hailstones, ice and other debris. Damage from foreign objects may take two forms. Smaller objects can erode the blade material and degrade the performance of the fan and engine. Impacts by larger objects on the blades may rupture or pierce the blades, and result in blade fragments or entire blades being dislodged and flying radially outward at high velocity, causing extensive secondary damage to adjacent and downstream blades and other engine components.

A number of approaches have been used to reduce the impact of foreign object damage. One known method is to add a metallic sheath called fan blade shield to protect the leading edge of the fan blade made from low-density metal or composites. The fan blade shield may help provide erosion protection for the fan blade and particularly for its leading edge. These leading edge protection shields allow the energy of the impact to be transmitted through the shield over a larger area than the impact position. Further, these shields might cause the energy of the impact to oscillate locally and/or to be displaced rapidly to a significant amplitude and fail. Finally, these shields may be made from materials such as, for example, titanium and nickel metals or alloys thereof, which have better strength and ductility when compared with the low-density metals or composite materials of the fan bade.

Titanium and its alloys have properties, such as high strength to weight ratios, good temperature and chemical resistance, and relative low densities, which make them ideal to be used as fan blade shields. But titanium alloys are extremely difficult to machine using conventional grinding tools, and costs associated with their machining are high due to a short tool life.

As is well known in fan blade technology, a fan blade can be manufactured by an electroforming process. In a typical electroforming process, a die or mandrel, made of a conductive material such as titanium, is formed to have an exterior surface that conforms to a blade's airfoil configuration minus the thickness of the sheath to be electroformed on the mandrel. Desired thicknesses of the sheath are achieved by a well-known process of “shielding”, in which barrier walls or shields are placed adjacent the mandrel in such positions that the shields direct the flow of an electroplate solution when the mandrels are placed in an electroplate bath. After the mandrel has been left in the electroplate bath for a pre-determined length of time, it is removed; the newly-electroformed sheath is next mechanically removed from the mandrel; and the sheath is then machined to smoothly fit over a low-density metal or composite component of the blade, in a manner well-known in the art.

However, the fan blade shields for gas turbine engines have become larger and longer. This physical limitation has made the process to manufacture electroformed sheaths of gas turbine engines time-consuming and cost-prohibitive because multiple steps of “shielding” are required to finish the whole length of the sheath. Further, known electroformed sheaths are typically limited in that a ratio of the thickness of the thickest part of the sheath (e.g., the leading edge of the sheath) to the thickness of the thinnest part of the sheath (e.g., the trailing edge of the sheath) is generally 5:1, and may reach 10:1 at a greater cost. The aforesaid ratio is hereinafter referred to as the “thickness range ratio”. But appropriate strength requirements for electroformed sheaths on modern fan blades mandate that a thickness range ratio as high as, for example, 80:1. These requirements present problems for the electroforming method for the fan blade shield.

Alternatively, the sheath can be made by another process called Electrical Discharge Machining (EDM). EDM is a manufacturing process whereby a desired shape is obtained by using electrical discharges. Materials are removed from the workpiece by a series of rapidly recurring current discharges between two electrodes, which are separated by a dielectric fluid and subject to an electric voltage. One of the electrodes is called the tool-electrode, while the other is called the workpiece-electrode.

If an EDM process is used to produce the sheath, multiple tool-electrodes will be required in the process because of the complex geometries of the sheath. Specifically, these electrodes are needed to match the geometry of the cavity in the sheath. EDM process removes metal materials by a series of rapidly reoccurring electrical discharges between an electrode (from the tool machine) and the workpiece (sheath) in the presence of a dielectric fluid. Minute solid particles of metal or chips or debris are removed by melting and vaporization, and flushed away from the newly created gap in the workpiece by the dielectric fluid, which is continuously flushed between the tool-electrode and the workpiece.

Common disadvantages of the EDM process to manufacture the sheath include slow rate of material removal, additional time and cost associated with creating electrodes during the process, difficulty in reproducing sharp corners in sheath, high power consumption, and excessive wear on tool-electrodes.

In sum, current manufacturing processes rely on the afore-mentioned electroforming or EDM processes to provide the geometry needed in fan blade shields. While effective to a point, they simply do not meet the demanding geometry requirements of high performance gas turbine engines into the future. To better answer the challenges raised by the gas turbine industry to produce reliable and high-performance gas turbines, it is therefore desirable to provide a better manufacturing method which affords fan blade shields with both operational efficiency and reasonable cost.

### SUMMARY OF THE DISCLOSURE

In accordance with one aspect of the present disclosure, a method for manufacturing a fan blade shield having a sheath cavity is therefore disclosed. The method may comprise: performing a sheath cavity grinding step for the fan blade shield; and performing a sheath cavity bottom grinding step for the fan blade shield. The fan blade shield may be made from a hard metal material comprising titanium metal, titanium metal alloys, or a combination thereof.

In a refinement, the sheath cavity grinding step may comprise: obtaining a first grinding machine having a grinding wheel made from a first superabrasive material; placing a rough block made from the hard metal material on a first workpiece holder of the first grinding machine; and grinding a crude sheath cavity into the rough block to make a crude fan blade shield.

In another refinement, the sheath cavity bottom grinding step may comprise: obtaining a second grinding machine having a grinding quill made from a second superabrasive material; placing the crude fan blade shield on a second workpiece holder of the second grinding machine; and grinding a sheath cavity bottom into the crude sheath cavity of the crude fan blade.

In another refinement, during grinding to form the sheath cavity, a coolant may be applied to the fan blade shield.

In another refinement, the fan blade shield may have a length of at least 10 inches.

In another refinement, the sheath cavity may have a depth of at least 1 inch.

In another refinement, the sheath cavity may have a width of at least 0.5 inches.

In another refinement, the first superabrasive material may comprise natural diamond, synthetic diamond, cubic boron nitride, or a combination thereof.

In another refinement, the grinding wheel is a vitrified abrasive grinding wheel.

In another refinement, the grinding wheel may include at least 35 volume percent porosity.

In another refinement, the second superabrasive material may comprise natural diamond, synthetic diamond, cubic boron nitride, or a combination thereof.

In another refinement, the grinding quill is a vitrified abrasive grinding wheel.

In still another refinement, the grinding quill may include at least 35 volume percent porosity.

In accordance with another aspect of the present disclosure, a method for forming a fan blade having a fan blade shield thereon is disclosed. The method may comprise: obtaining a fan blade body; obtaining a fan blade shield having a sheath cavity matching a leading edge of the fan blade; and attaching the fan blade shield to the leading edge of the fan blade body to produce the fan blade. The fan blade shield may be obtained by a process comprising: performing a sheath cavity grinding step for the fan blade shield; and performing a sheath cavity bottom grinding step for the fan blade shield. The fan blade shield may be made from a hard metal material comprising titanium metal, titanium metal alloys, or a combination thereof.

In a refinement, the sheath cavity grinding step of the fan blade forming method may comprise: obtaining a first grinding machine having a grinding wheel made from a first superabrasive material; placing a rough block made from the hard metal material on a first workpiece holder of the first grinding machine; and grinding a crude sheath cavity into the rough block to make a crude fan blade shield.

In another refinement, the sheath cavity bottom grinding step of the fan blade forming method may comprise: obtaining a second grinding machine having a grinding quill made from a second superabrasive material; placing the crude fan blade shield on a second workpiece holder of the second grinding machine; and grinding a sheath cavity bottom into the crude sheath cavity of the crude fan blade.

In another refinement, the first superabrasive material used in the fan blade forming method may comprise natural diamond, synthetic diamond, cubic boron nitride, or a combination thereof.

In another refinement, the grinding wheel used in the fan blade forming method may include at least 35 volume percent porosity.

In another refinement, the second superabrasive material used in the fan blade forming method may comprise natural diamond, synthetic diamond, cubic boron nitride, or a combination thereof.

In still another refinement, the grinding quill used in the fan blade forming method may include at least 35 volume percent porosity.

Further forms, embodiments, features, advantages, benefits, and aspects of the present disclosure will become more readily apparent from the following drawings and descriptions provided herein.

### BRIEF DESCRIPTION OF THE DRAWINGS

FIG. 1 is a cross-sectional view of a gas turbine engine whose fan blade shields are constructed in accordance with the teachings of this disclosure;

FIG. 2 is a fragmentary perspective view of a fan section of a gas turbine engine employing fan blade shields constructed in accordance with the present disclosure;

FIG. 3 is a fragmentary perspective view of a fan blade shield according to an embodiment of the present disclosure;

FIG. 4 is another fragmentary perspective view of the fan blade shield in FIG. 3;

FIG. 5 is a is a flow chart depicting a method of manufacturing a fan blade shield according to the present disclosure;

FIG. 6 is a fragmentary perspective view of a superabrasive grinding wheel working on a fan blade shield according to the present disclosure;

FIG. 7 is a fragmentary perspective view of another superabrasive grinding wheel working on a fan blade shield according to the present disclosure;

FIG. 8 is a fragmentary perspective view of a superabrasive grinding quill working on a fan blade shield according to the present disclosure; and

FIG. 9 is a fragmentary perspective view of another superabrasive grinding quill working on a fan blade shield according to the present disclosure.

Before proceeding with the detailed description, it is to be appreciated that the following detailed description is merely exemplary in nature and is not intended to limit the invention or the application and uses thereof. In this regard, it is to be additionally appreciated that the described embodiment is not limited to use in conjunction with a particular fan blade shield or a particular type of gas turbine. Hence, although the present disclosure is, for convenience of explanation, depicted and described as shown in certain illustrative embodiments, it will be appreciated that it can be implemented in various other types of embodiments and equivalents, and in various other systems and environments.

### DETAILED DESCRIPTION OF THE DISCLOSURE

For simplicity and illustrative purposes, the principles of the disclosure are described by referring to an embodiment thereof. As used herein, the term “workpiece” refers to an object being worked on with a tool or machine. The term “about” means plus or minus 10% of the numerical value of the number with which it is being used. Therefore, about 40% means in the range of 35%-55% for example. Further, the term “fan blade shield” means both the final fan blade shield product and the intermediate workpiece which is machined to make the final fan blade shield product.

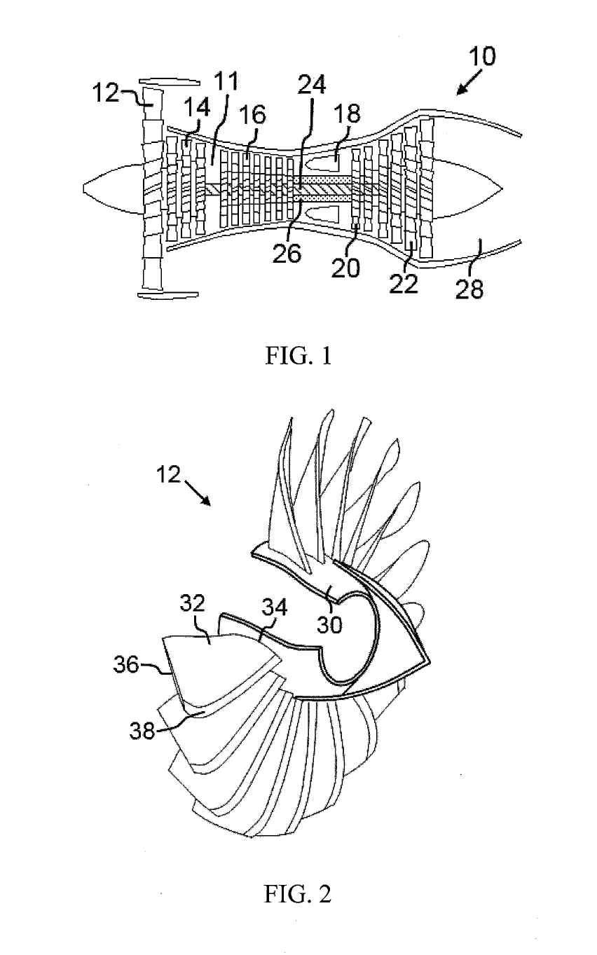

Referring now to the drawings, and with specific reference to FIG. 1, there is depicted an exemplary gas turbine 10 wherein various embodiments of the present disclosure may be utilized. In this example, the industrial gas turbine 10 may include a compressor section 11 which may comprise, sequentially from the forefront of the gas turbine engine 10, a fan 12, a low pressure compressor 14, a high pressure compressor 16, a combustor chamber 18 downstream of the compressor section 11, a high pressure turbine 20 and a low pressure turbine 22 downstream of the combustor chamber 18. Further, a low pressure shaft 24 may couple the low pressure compressor 14 with the low pressure turbine 22; while a high pressure shaft 26 may couple the high pressure compressor 16 with the high pressure turbine 20.

During operation, air suctioned by the fan 12 may be pressurized in the compressors 14 and 16, and mixed with fuels in the combustor 18 to generate hot gases. The hot gases may flow through the turbines 20 and 22, which extract energy from the hot gases. The turbines 20 and 22 may then power the compressors 14 and 16 as well as the fan section 12 through rotor shafts 24 and 26. Finally, the exhaust gases may exit the gas turbine engine through an exhaust 28. In power generation applications, the turbines 20 and 22 may connect to an electric generator to generate electricity; while in aerospace applications, the exhaust of the turbine 10 can be used to create thrust.

FIG. 2 depicts a perspective view of a fan 12, with certain components removed, according to the present disclosure. The fan 12 may comprise a fan disk 30 centered on the rotation axis of the gas turbine engine; and a plurality of fan blades 32 attached to the fan disk 30 and spaced apart in the circumferential or tangential direction. The fan blade 32 may include a hub end 34 attached to the fan disk 30 and a remote end 36 away from the hub end 34. Further, the fan blade 32 may have a fan blade shield 38 that extends from the remote end 36 to the hub end 34 along the curved leading edge of the fan blade 32. It is noted that the fan blade shield 38 is curved and has a twist from the remote end 36 to the hub end 34, matching the geometry of the leading edge of the fan blade 32.

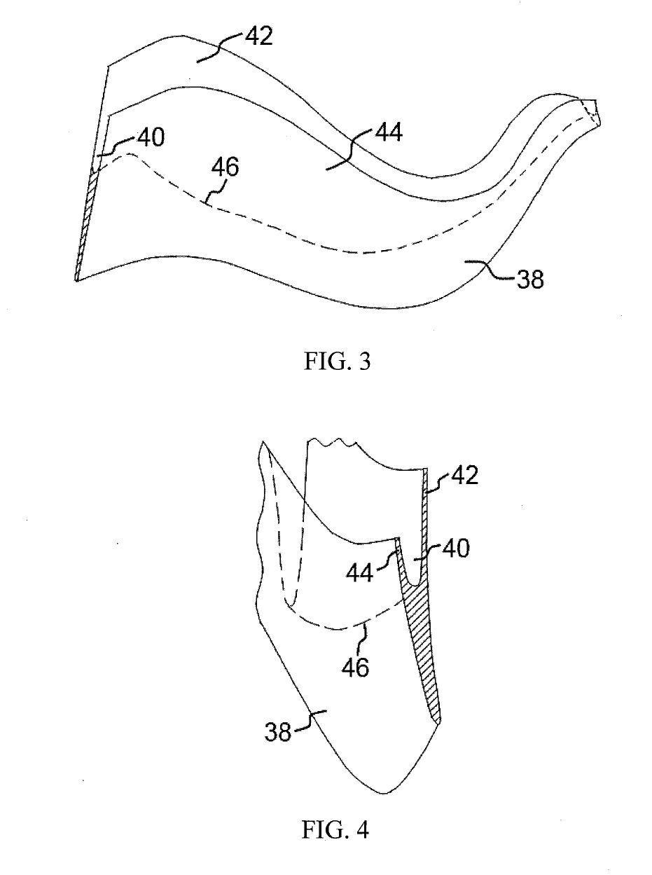

Turning now to FIGS. 3-4 for perspective views of a fan blade shield 38 constructed according to the present disclosure. Again, the fan blade shield 38 maybe curved and twisted in terms of its overall geometry. The total length of the fan blade shield may be, for example, about 10 inches, about 20 inches, about 30 inches, about 40 inches or even longer, which makes it difficult and expensive to be made by electroforming or EDM processes. Further, the fan blade shield 38 may comprise a sheath cavity 40 which is formed in-between a first protection side 42 and a second protection side 44. A sheath cavity bottom 46, where the first protection side 42 and the second protection side 44 meet, matches the contour of the leading edge of the fan blade 32. Although the fan blade shield 38 and its components are shown as having certain relative dimensions, such dimensions are only exemplary and other relative dimensions are possible.

The fan blade shield 38 may be made of titanium metal or titanium alloy materials, any other suitable materials, or combinations thereof. As indicated above, it has been shown that the fan blade shield 38 may have a long, narrow, curved and twisted sheath cavity 40, which, if manufactured by either an electroforming or an EDM process, would be time-consuming and costly. The inventor has found that large diamond and/or cubic boron nitride (CBN) grinding wheels can be used to remove most of the material from the sheath cavity 40 followed by finishing the sheath cavity bottom 46 with small quill type of milling cutter, diamond and CBN quills.

Diamond is the hardest of all known materials, which has become increasingly important for machining. Today in abrasive engineering practice synthetic diamond grit is often the material of choice. As a result of its fine crystalline structure and the accompanying properties, for example, maximum abrasion resistance and edge-holding quality, diamond is superior to all other abrading media. Diamond belongs to the superabrasive group of cutting materials. The application of diamond in abrasive engineering is restricted by its thermal load capacity if subjected to temperatures exceeding, for example 700° C., due to its solubility in iron, nickel, and related alloys at such high temperatures. Therefore, diamond tools can be used to machine titanium and titanium alloy materials under appropriate conditions.

On the other hand, CBN is a synthetic material and the second hardest abrading medium after diamond. Due to its chemical-physical properties, CBN is primarily used to process hard-to-machine steels with a high alloy content and/or hardness. Like diamond, CBN belongs to the superabrasive group of cutting materials. CBN can withstand temperatures of up to, for example, 1300° C. and has a tendency to react chemically with certain metals. Due to its fine crystalline structure and the resulting properties, for example, high abrasion resistance and edge-holding quality, CBN offers an advantage for grinding hard-to-machine and hardened steels or alloyed steels. During operation, lowering the temperature during grinding prevents changes in the structure of the CBN material edge zone. Accordingly, high accuracy regarding dimension, shape and concentricity as well as long tool life can be achieved using CBN grinding tools.

With these current abrasive engineering practices and limitations in mind, the fan blade shields of the present disclosure are treated by a process described herein to achieve improved efficiency, shortened processing time, and reduced cost. In so doing, the resulting fan blade shields demonstrate comparable, if not superior, performance in comparison to shields that are formed by previous methods. Aerospace components utilizing such fan blade shields can therefore achieve improved manufacturing efficiency and lower overall cost as well.

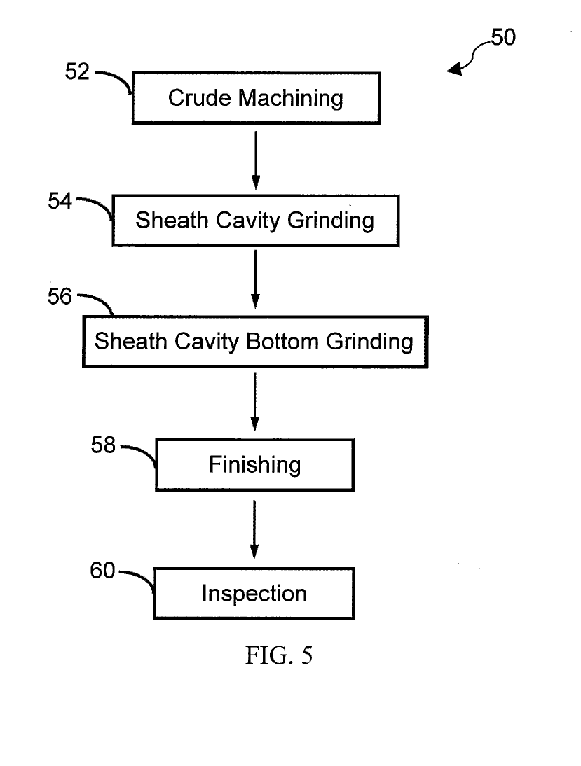

Referring now to FIGS. 5-7, a method for manufacturing fan blade shields according to the present disclosure is shown in detail. More specifically, one embodiment of the process of the present disclosure, indicated generally by the numeral 50 in FIG. 5, may sequentially include a crude machining step 52, a sheath cavity grinding step 54, a sheath cavity bottom grinding step 56, a finishing step 58, and an inspection step 60, each of which will now be described in greater detail in the paragraphs that follow for a fan blade shield.

The crude machining step may include steps necessary to produce blocks from a stock material. For example, it may include making a rough block from a bigger stock material by cutting or grinding a predetermined, 3-dimensional shape out of the stock material. The predetermined shape may be, for example, a rectangular block, or other regular or irregular shapes. The peripheral dimensions of the block may be bigger than the desired size of the fan blade shield to a degree determined appropriate by a person skilled in the art. At the end of the crude machining step 52, the rough block may be produced at a desired dimension; for example, at least 0.010 inch oversized in length/width/height. Other dimensions for the rough block are possible. The fan blade shield may be made of a material comprising titanium, titanium alloy, other suitable materials, or combinations thereof.

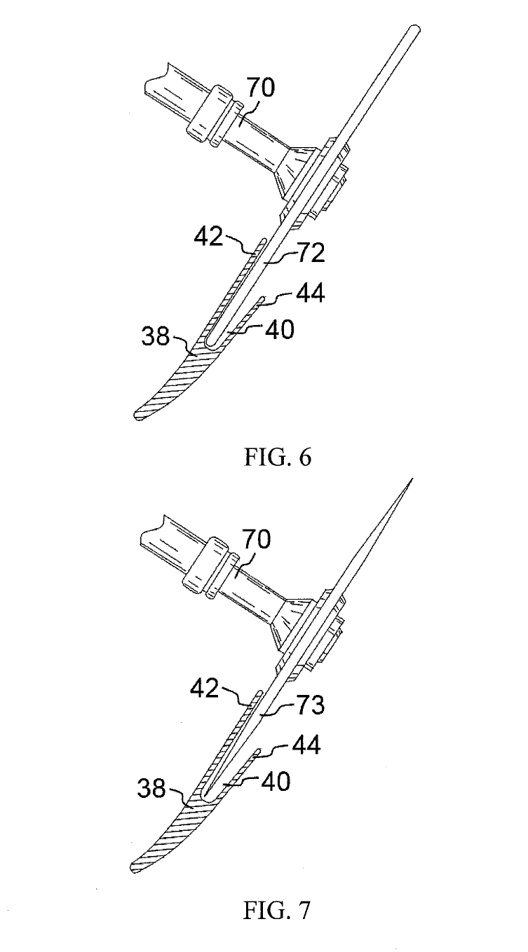

After the rough block is produced in the crude machining step 52, the sheath cavity grinding step 54 may remove the bulk of material of the cavity from the block obtained in step 52. For example, as shown in FIG. 5-7, the step 54 may include: providing a suitable grinding machine 70 with a matching grinding wheel 72; securing the block to be ground on a workpiece holder; engaging the grinding wheel 72/73 with the block so that the grinding wheel 72/73 touches the block at a predetermined position, rotatably moves along a predetermined direction, and cuts away materials from the block; removing the debris from the newly generated cavity, and stopping when the cavity 40 is generally formed between the first protection side 42 and the second protection side 44. Certain aspects of the sheath cavity, for example, the sheath cavity bottom, may not be in the final size/shape after the step 54. But the sheath cavity grinding step 54 may provide the crude cavity within a short time. During the grinding process, a lubricant may be used and applied to the surface of the sheath cavity 40 during the grinding. In addition, a coolant such as, for example, a water-based coolant, or a water-soluble oil-based coolant, may be applied with appropriate temperature, flow rate and pressure conditions to facilitate the grinding process. The machining of the sheath may require multi-axis machine motion such as 5-axis machining. In addition, fluids used during machining using CBN abrasives may include mil-based coolants, for example, straight mineral oils. While the grinding wheel 72 as shown in FIG. 6 is a relatively flat disk with a relatively uniform thickness, the grinding wheel 73 in FIG. 7 is a disk which becomes gradually thinner near its peripheral. In certain roughing operations to remove more materials using multi-axis motion, a tapered grinding wheel such as grinding wheel 73 may be beneficial due to the increased pressure at the wheel peripheral.

On one hand, the grinding machine 70 may be, for example, a conventional creepfeed grinding machine or other suitable grinding machine designed to carry out high efficiency deep grinding process, including but not limited to, for example, a multi-axis machining center. With a multi-axis machining center, both the sheath cavity cutting and the complex shape forming for the protection sides can be carried out on the same machine. The sheath cavity grinding step may be carried out at specific cutting energies similar to or different from those of traditional grinding operations. Multiple passes may be carried out with a single grinding wheel 72 or 74.

On the other hand, the grinding wheel 72/73 may have superabrasive materials on its cutting edge. The superabrasive materials may comprise, for example, diamonds, CBN materials, or a combination thereof. Although the grinding machine 70 and the grinding wheel 72/73 are shown to have certain relative dimensions, other dimensions are possible. The selection of the grinding machine 70 and the grinding wheel 72/73 can be made by a person skilled in the art according to the dimensions of each fan blade shield he or she is working on and the dimensions of the sheath cavity of the fan blade shield. Procedures to operate the grinding machine 70 are known to an ordinary person skilled in the art. For example, parameters related to operation of the grinding wheel 72/73 such as, for example, wheel speed, work speed, traverse rate, and depth of cut per pass, can be chosen according to each grinding task. The wheel speed of the grinding wheel 72/73 may be about 3,000 to 5,000 RPM, or may be about 1,000 to 3,000 RPM, depending on the each fan blade shield. Other wheel speeds are possible.

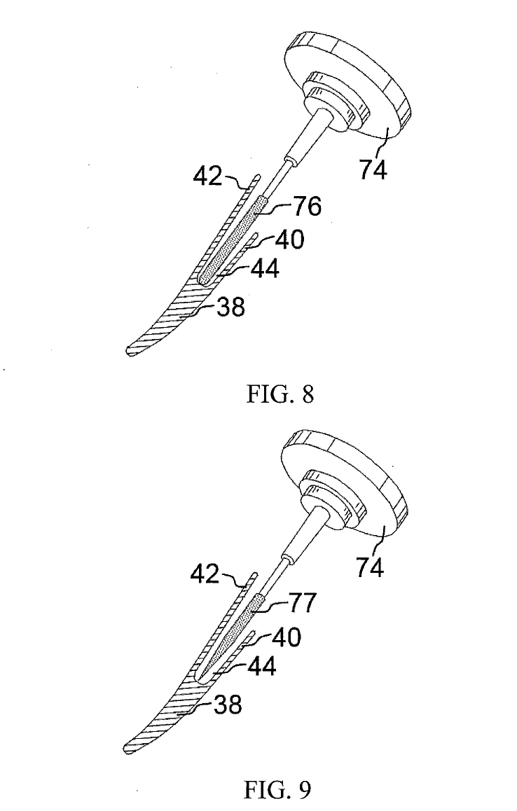

The next step is the sheath cavity bottom grinding step 56 which may comprise steps necessary to afford the desired sheath cavity bottom. For example, as shown in FIG. 8-9, the step 54 may include: providing a suitable grinding machine 74 with a matching grinding quill 76/77; securing the crude fan blade shield obtained from step 54 on a workpiece holder; engaging the grinding quill 76/77 with the workpiece so that the grinding quill 76/77 touches the crude sheath cavity bottom at a predetermined position, rotatably moves along a predetermined direction and path, and cuts away materials from the crude cavity bottom; removing the debris from the newly generated cavity bottom, and stopping when the cavity bottom of the cavity 40 is formed according to predetermined specifics for an intermediate fan blade shield. While the grinding quill 76 as shown in FIG. 8 is a cylinder with uniform diameter, the grinding quill 77 in FIG. 9 is a tapered cone shape whose diameter becomes gradually smaller at the end. In certain cavity grinding operations to complete the cavity using multi-axis motion, a tapered grinding quill such as grinding quill 77 may be beneficial due to the increased pressure at the quill peripheral

The grinding machine 74 may be any suitable grinding machine designed to carry out high efficiency grinding processes. The grinding tool for the step 56 may be a small quill type of milling cutter made from a superabrasive material such as, for example, diamond and CBN. A lubricant and/or a coolant may be used and applied to the sheath cavity bottom during the grinding step 56. Procedures to operate the grinding machine 74 are known to an ordinary person skilled in the art. For example, parameters of the grinding quill 76/77 such as, for example, quill speed, work speed, and depth of cut per rotation/pass, can be chosen according to each grinding task. For instance when a small quill type of tool is used for finishing, the quill speed may be about 50,000 to 100,000 RPM to achieve the required peripheral speed. Other quill speeds are possible.

Even though the grinding machines 70 and 74 are presented as different machines above, they may be the same machine as well. For example, the roughing with the grinding wheel and the finishing with the grinding quill type tool can be done on one grinding machine that is equipped with 2 spindles.

After the sheath cavity bottom is formed, a finishing step 58 may be performed to finally transform the intermediate fan blade shield into the correct form and dimensions of the final fan blade shield. The finishing step may include: hardfacing; peening; descaling; grinding; filing; polishing; burnishing; washing; and drying. At the end of the finishing step 58, the desired fan blade shield 38 is obtained.

Finally, the inspection step 60 includes a final inspection of the fan blade shield for size, form, surface finish, chatter and feed marks, surface roughness, thermal degradation, taper quality and tolerance against the desired specifications. This step may be conducted on a sampling basis or by other methods needed for the sake of efficiency. Moreover, the inspection step 60 may rely on analysis performed by means of microscopes and other precision equipment. If any are found to be out of tolerance, additional steps of cold treatment, heading, grinding, cleaning, descaling, and cutting or any of the foregoing steps may be conducted again to try and reach acceptance.

As to the physical dimensions of the fan blade shield 38, it may be at least 10 inches in length for example. In addition, the sheath cavity may have a depth of at least 1.0 inch. Furthermore, the sheath cavity may have a width of at least 0.5 inches. Other dimensions are possible.

The fan blade shield thus formed can be attached to a corresponding fan blade body using a known method such as, for example, resin transfer molding process and adhesive film process. Any conventional adhesive used to bond metal such as titanium and nickel to materials such as metals or composites, from which the fan blade body is made, may be used in this step. Heat may be applied to cure the resin at a low pressure that reduces the potential for movement of the fibers in the composite material of the fan blade body. The resin can be an epoxy polymer resin system or any other resin system conventionally used in resin transfer molding products such as, for example, airfoil blades that operate at high temperatures and other stress-inducing conditions. A primer may also be used prior to application of the adhesive. Any adhesive films suitable to glue the fan blade body with the fan blade shield may be used.

Ordinary high-speed rotation of the resulting fan blade 32 may result in contact with foreign objects being limited to contact with the leading edge of the fan blade 32. Before any such foreign object could reach and damage the fan blade body components which may be made from low-density metals or composites, it would have to completely penetrate the fan blade shield 38. Consequently because of the length of the fan blade shield 38 and the thickness of both the first protection side 42 and the second protections side 44, the fan blade shield 38 made by the process of the present disclosure affords substantially enhanced protection for the fan blade 32.

It will be apparent to an ordinary person skilled in the art that the present disclosure can be carried out using different grinding wheels and/or grinding quills. For example, the superabrasive grinding tools, such as the grinding wheel 72 and the grinding quill 76, may be inorganic bonded system such as, for example, a vitrified or ceramic bond system, and may use a superabrasive material such as, for example, diamonds or CBN. Examples of vitrified bond systems may include the bonds characterized by improved mechanical strength known in the art, for use with conventional fused aluminum oxide or microcrystalline alpha-alumina (MCA, also referred to as sintered sol gel alpha-alumina) abrasive grits.

Further, fits may be used in combination with the raw vitreous bond materials or in lieu of the raw materials. The bond system may include at least two amorphous glass phases with the CBN grain to yield greater mechanical strength for the bond base. The superabrasive tools may include about 10-40 volume % of inorganic materials such as, for example, glass fit, including, but not limited to borosilicate glass, feldspar and other glass compositions. The superabrasive grinding tools may include about 10-60 volume % of a superabrasive material.

In addition, the superabrasive tools may contain about 10-70 volume % porosity. The porosity is formed by either the natural spacing caused by the natural packing density of the materials or pore-inducing media, including, but not limited to, hollow glass beads, ground walnut shells, beads of plastic materials, foamed glass particles and bubble alumina, elongated grains, fibers and combinations thereof.

As to the superabrasive component, any suitable superabrasive materials known in the art may be used. By definition, a superabrasive material is one having a Knoop hardness of at least 3000 kg-f/m² (a Knoop hardness number of 3000 KHN), or even at least 4200 kg-f/m² (4200 KEN). They may include synthetic or natural diamond, CBN, and mixtures thereof. Optionally, a coating such as, for example, nickel, copper, titanium, or any wear resistant or conductive metal, may be deposited on the superabrasive crystal of choice.

The superabrasive materials may be monocrystalline or microcrystalline CBN particles, or any combinations thereof. The superabrasive materials may include CBN of a grit size ranging from about 60/80 mesh size to about 400/500 mesh size or ranging from about 80/100 mesh size to about 700/800 mesh size.

Secondary abrasive grains may be added to account for about 0.1-40 volume % of the superabrasive tools. These grains may include but are not limited to, aluminum oxide, silicon carbide, flint and garnet grains, and combinations thereof. When manufacturing the superabrasive tools, organic binders may be added to the powdered bond components, flitted or raw, as molding or processing aids. The binders may include dextrins and other type of adhesives, a liquid component such as, for example, water or ethylene glycol, viscosity of pH modifiers and mixing aids. These binders may or may not become part of the final grinding tools depending on the manufacturing process.

### INDUSTRIAL APPLICABILITY

From the foregoing, it can be seen that the present disclosure describes a method to manufacture fan blade shield which can find applicability in industrial gas turbines. Such a manufacturing method may also find industrial applicability in many other applications including, but not limited to, aerospace applications such as manufacturing fan blade shield for gas turbine engines.

There are a number of benefits obtained by the process of this disclosure. Conventional manufacturing processes to produce fan blade shield are time-consuming, expensive and limited by certain process parameters. Current demand to make long, irregularly-shaped fan blade shields exceeds the capacity of conventional manufacturing processes. By combining the strengths of a superabrasive grinding wheel and a superabrasive grinding quill, the present disclosure enables a quicker, cheaper and more effective process to afford fan blade shields for gas turbine engines. The fan blade shields can be formed using a straightforward machining process rather than a lengthy, stepwise and expensive EDM process. In addition, the present disclosure also provides a novel alternative to meet advanced requirements for fan blade shields of the engines. Accordingly, the present disclosure opens up new possibilities for gas turbine engine which have heretofore been limited by conventional method to produce the fan blade shield, and which may reduce manufacturing costs and shorten manufacturing lead time.

While the invention has been described with reference to certain embodiments, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A method for manufacturing a fan blade shield for a gas turbine engine, the fan blade shield having a sheath cavity, the method comprising:
performing a sheath cavity grinding step for the fan blade shield; and
performing a sheath cavity bottom grinding step for the fan blade shield, wherein the fan blade shield is made from a hard metal material comprising titanium metal, titanium metal alloys, or a combination thereof.

2. The method of claim 1, wherein the sheath cavity grinding step comprises:
obtaining a first grinding machine having a grinding wheel made from a first superabrasive material;
placing a rough block made from the hard metal material on a first workpiece holder of the first grinding machine; and
grinding a crude sheath cavity into the rough block to make a crude fan blade shield.

3. The method of claim 2, wherein the sheath cavity bottom grinding step comprises:
obtaining a second grinding machine having a grinding quill made from a second superabrasive material;
placing the crude fan blade shield on a second workpiece holder of the second grinding machine; and
grinding a sheath cavity bottom into the crude sheath cavity of the crude fan blade.

4. The method of claim 1, wherein during grinding to form the sheath cavity, a coolant is applied to the fan blade shield.

5. The method of claim 1, wherein the fan blade shield has a length of at least 10 inches.

6. The method of claim 1, wherein the sheath cavity has a depth of at least 1 inch.

7. The method of claim 1, wherein the sheath cavity has a width of at least 0.5 inches.

8. The method of claim 2, wherein the first superabrasive material comprises natural diamond, synthetic diamond, cubic boron nitride, or a combination thereof.

9. The method of claim 2, wherein the grinding wheel is a vitrified abrasive grinding wheel.

10. The method of claim 2, wherein the grinding wheel includes at least 35 volume percent porosity.

11. The method of claim 3, wherein the second superabrasive material comprises natural diamond, synthetic diamond, cubic boron nitride, or a combination thereof.

12. The method of claim 3, wherein the grinding quill is a vitrified abrasive grinding wheel.

13. The method of claim 3, wherein the grinding quill includes at least 35 volume percent porosity.

14. A method for forming a fan blade for a gas turbine engine, the fan blade having a fan blade shield, the method comprising:
obtaining a fan blade body;
obtaining the fan blade shield having a sheath cavity matching a leading edge of the fan blade body, the fan blade shield being obtained by a process comprising:
performing a sheath cavity grinding step for the fan blade shield; and
performing a sheath cavity bottom grinding step for the fan blade shield, wherein the fan blade shield is made from a hard metal material comprising titanium metal, titanium metal alloys, or a combination thereof; and
attaching the fan blade shield to the leading edge of the fan blade body to produce the fan blade.

15. The method of claim 14, wherein the sheath cavity grinding step comprises:
obtaining a first grinding machine having a grinding wheel made from a first superabrasive material;
placing a rough block made from the hard metal material on a first workpiece holder of the first grinding machine; and
grinding a crude sheath cavity into the rough block to make a crude fan blade shield.

16. The method of claim 15, wherein the sheath cavity bottom grinding step comprises:
obtaining a second grinding machine having a grinding quill made from a second superabrasive material;
placing the crude fan blade shield on a second workpiece holder of the second grinding machine; and
grinding a sheath cavity bottom into the crude fan blade.

17. The method of claim 15, wherein the first superabrasive material comprises natural diamond, synthetic diamond, cubic boron nitride, or a combination thereof.

18. The method of claim 15, wherein the grinding wheel includes at least 35 volume percent porosity.

19. The method of claim 16, wherein the second superabrasive material comprises natural diamond, synthetic diamond, cubic boron nitride, or a combination thereof.

20. The method of claim 16, wherein the grinding quill includes at least 35 volume percent porosity.
